(19) United States
(12) Patent Application Publication
(10) Pub. No.: US 2024/0428045 A1
(43) Pub. Date: Dec. 26, 2024

(54) COLLABORATIVE AUGMENTED LANGUAGE MODELS FOR CAPTURING AND UTILIZING DOMAIN EXPERTISE

(71) Applicant: Aitomatic, Inc., Cupertino, CA (US)

(72) Inventors: Christopher Nguyen, Los Altos, CA (US); Roshan Devan Nanu, Worcester, MA (US); Hong An Phan, San Jose, CA (US); Tri Cao Le, Ho Chi Minh City (VN); Thao Phuong Nguyen, Ho Chi Minh City (VN); Loc Tan Nguyen, Ho Chi Minh City (VN); Tuan Hoang Pham, Ho Chi Minh City (VN); Hung Phi Vo, Ho Chi Minh City (VN); Phuoc Le Trong Bui, Ha Noi (VN); Zooey Nhu-Quynh Nguyen, Los Altos, CA (US); Sang Xuan Dinh, Ho Chi Minh City (VN); Nam Hoai Vuong, Ho Chi Minh City (VN)

(21) Appl. No.: 18/754,141

(22) Filed: Jun. 25, 2024

Related U.S. Application Data
(60) Provisional application No. 63/510,335, filed on Jun. 26, 2023.

(51) Int. Cl. G06N 3/006

(52) U.S. Cl. CPC G06N 3/006

(57) ABSTRACT

A system captures and utilizes expert knowledge in artificial intelligence. The system includes a knowledge capture module for extracting expert knowledge from subject matter experts in a conversational format and a knowledge management module for cataloging and summarizing the extracted knowledge. The system also includes a digital subject matter expert (dSME) module for ingesting the cataloged knowledge and using it to guide users in building AI models. A chatbot interacts with a user and selects the appropriate dSME module that is relevant to the user request. The system attempts to answer the user request based on the dSME module. If the dSME module lacks knowledge to solve the problem, the system uses a set of tools, for example, internet based search engine to solve the problem.

### CROSS REFERENCE TO RELATED APPLICATION

This application claims priority to U.S. Provisional Patent Application Ser. No. 63/510,335, filed on Jun. 26, 2023, which is herein incorporated by reference in its entirety.

### FIELD OF INVENTION

The disclosure relates in general to artificial intelligence and machine learning techniques, and more specifically to capturing and utilization of expert knowledge in development of artificial intelligence-based systems.

### BACKGROUND

Artificial intelligence (AI) techniques are useful for several industrial systems. For example, machine learning based models are used for making predictions used in industrial processes. There are several challenges in developing artificial intelligence techniques for industrial systems. For example, the development of AI solutions can be time-consuming and requires a significant amount of data and expert knowledge. The unavailability of large-scale data in the physical space and the lack of communication between data scientists and subject matter experts can lead to long development times for AI solutions. AI solutions based on incomplete information can provide inaccurate and incomplete results.

### SUMMARY

A system answers domain specific problems specified by users using natural language requests. The system receives a natural language request for answering a question from one of a plurality of domains. The natural language request comprising a domain specific problem. The system determines whether any of a plurality of domain specific models are configured to answer the domain specific problem. Each of the plurality of domain specific models stores a knowledge base specific to a domain. If the system determines that at least one of the plurality of domain specific models is configured to answer the domain specific problem specified in the natural language request, the system selects a domain specific model from a plurality of domain specific models for answering the domain specific problem. The system executes the domain specific model to answer the domain specific problem. If the system determines that none of the plurality of domain specific models can answer the domain specific problem, the system selects a software tool from a plurality of software tools for answering the domain specific problem. The system sends a request to the software tool for answering the domain specific problem.

Embodiments perform steps of the methods disclosed hereon. Embodiments include computer readable storage media storing instructions for performing the steps of the above method. Embodiments include computer systems that comprise one or more computer processors and a computer readable storage medium store instructions for performing the steps of the above method.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows the overall system environment for a knowledge based AI system, in accordance with an embodiment of the invention.

FIG. 2 shows the system architecture of a knowledge first system, in accordance with an embodiment.

FIG. 3 illustrates the overall process for making predictions, according to an embodiment of the invention.

FIG. 4 shows a development system for use for building AI systems according to an embodiment.

FIG. 5 illustrates the overall architecture of the knowledge based AI system according to an embodiment.

FIG. 6 illustrates the overall process of making predictions using the knowledge based AI system according to an embodiment.

FIG. 7 illustrates the use of various tools for use with knowledge based AI system 150 according to an embodiment.

FIGS. 8-11 illustrate the use of the knowledge based AI system for applications according to various embodiments.

FIG. 12 shows the architecture of the system for developing AI solutions according to an embodiment.

FIG. 13 illustrates the interactions between various components of the system according to an embodiment.

FIG. 14 illustrates four Knowledge-First (K1st) Architectures according to various embodiments.

FIG. 15 shows a flowchart illustrating the process of answering domain specific natural language requests, according to an embodiment.

FIG. 16 is a high-level block diagram illustrating an example system, in accordance with an embodiment.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### DETAILED DESCRIPTION

The system according to an embodiment captures and utilizes expert knowledge in AI development for applications such as industrial systems. A user interacts with a chatbot (referred to herein as an assistant chatbot) which in turn interacts with various tools to solve the user's problem. For example, the user may ask a natural language question to the assistant chatbot providing information about a problem (e.g., with an equipment) requesting the assistant chatbot 1320 to diagnose the problem. The assistant chatbot answers the question if the assistant chatbot has the right information/knowledge or else the assistant chatbot determines which tool (or component) to interact with to get the answer. The assistant chatbot interacts with one or more tools to solve the user's problem, for example, various specialized LLMs, web search tool 1340, math processing tool 1350 (e.g., Wolfram math tool), a problem solver LLM 1330 for generating a set of steps for solving a problem, and so on.

### System Environment

A system according to an embodiment, implements a knowledge-first architecture that allows knowledge of an expert, for example, a domain expert to be incorporated into the development and use of an AI system. The system is referred to as a knowledge based AI system or as a knowledge first system. An AI system includes one or more predictive nodes, each node representing a computational system that receives input data and makes one or more predictions that may be used for system functions. For example, the input data may be sensor data generated by an industrial system and the prediction may indicate whether there is a fault in the industrial system.

According to an embodiment, the knowledge based AI system comprises a predictive unit that uses a knowledge model both to provide training labels for a generalized ML model and to provide predictive output for a functional system even in absence of a well trained ML model. The system also contains an ensemble model which aggregates the outputs of both the expert-made knowledge model and the generalized (ML) model and outputs a final decision. This ensemble model can combine these outputs in a number of ways. According to an embodiment, the ensemble model combines the outputs using a logical AND operation or an OR operation between the outputs of the generalized ML model and the knowledge model. According to other embodiments, the ensemble model inspects the model accuracy of the ML model and prioritizes the knowledge model output if ML model accuracy is low. According to an embodiment, the ensemble model is implemented as an ML model, learning to optimally use both ML and knowledge outputs to generate a final decision for system operation.

The knowledge model can also have many forms and be adapted to suit many use-cases. The simplest implementations are logical operations on the input data to either output a boolean classification or more detailed categorical labels. In the case of predictive maintenance and fault prediction use cases, unsupervised anomaly detection is done on the input dataset before passing the data for anomaly points on to the Oracle. In this case the knowledge model incorporates the expertise of someone with years of experience in maintaining the system in question. The expert users specify rules related to the original sensor variables such as ‘If sensor A>threshold A and sensor B<threshold B then output error C’. In this way a knowledge model classifies the anomalous data point as a specific type of error. Early on, this aids in system operation, but as data is accumulated and labelled by the knowledge model, the associated ML model becomes more accurate and functional until both models contribute valuable output and the ensemble model utilizes insight from both to draw a final conclusion.

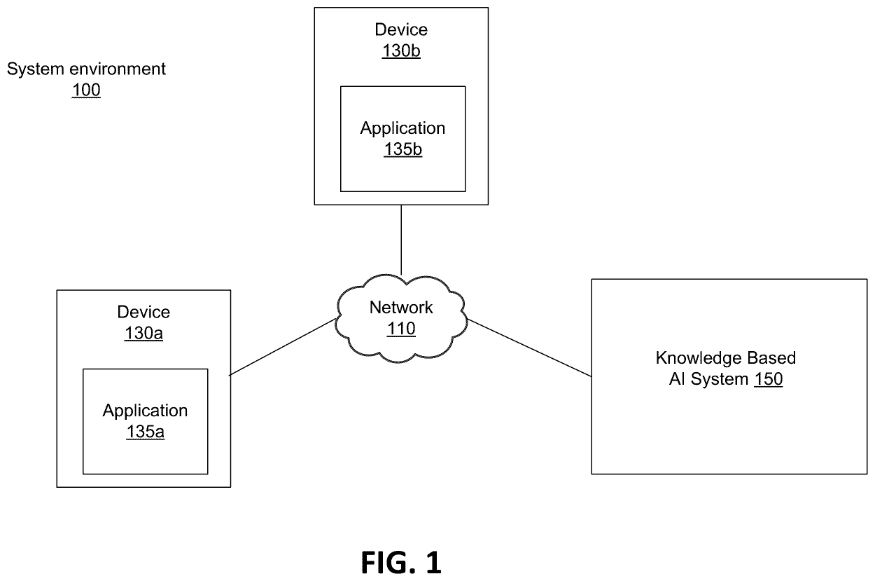

FIG. 1 shows the overall system environment for a knowledge based AI system, in accordance with an embodiment of the invention. The overall system environment includes one or more devices 130, a knowledge based artificial intelligence system or a knowledge based AI system 150, and a network 110. Other embodiments can use more or less or different systems than those illustrated in FIG. 1. Functions of various modules and systems described herein can be implemented by other modules and/or systems than those described herein.

FIG. 1 and the other figures use like reference numerals to identify like elements. A letter after a reference numeral, such as “130a,” indicates that the text refers specifically to the element having that particular reference numeral. A reference numeral in the text without a following letter, such as “130,” refers to any or all of the elements in the figures bearing that reference numeral (e.g., “130” in the text refers to reference numerals “130” and/or “130” in the figures).

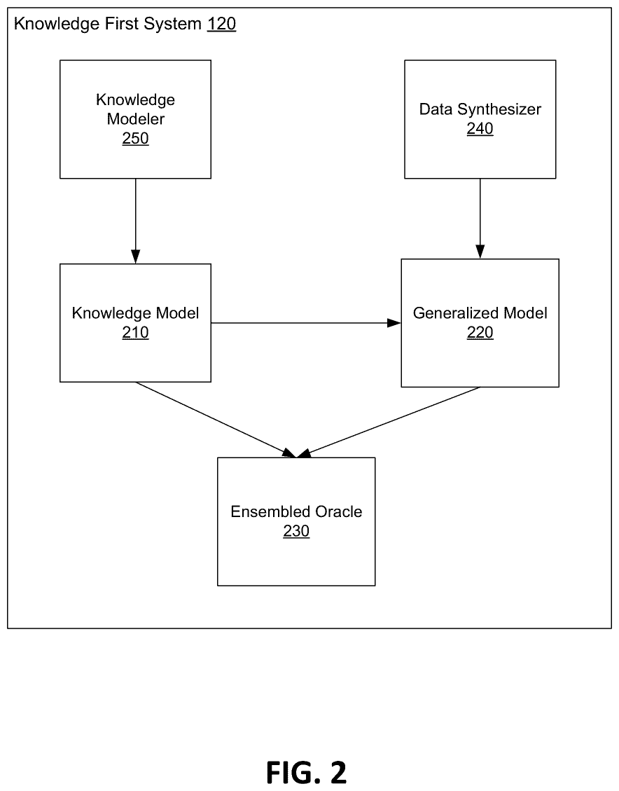

The knowledge based AI system 150 allows experts to configure rules for making predictions related to a system. The knowledge based AI system 150 further generates models, for example, machine learning models for making predictions. The knowledge based AI system 150 combines results of the rule based system and machine learning base system to make predictions. Further details of the knowledge based AI system 150 are illustrated in FIG. 2 and described in connection with FIG. 2. A device can be any physical device, for example, a device connected to other devices or systems via Internet of things (IoT). The IoT represents a network of physical devices, vehicles, home appliances and other items embedded with electronics, software, sensors, actuators, and connectivity which enables these objects to connect and exchange data. A device can be a sensor that sends sequence of data sensed over time.

The sequence of data received from a device may represent data that was generated by the device, for example, sensor data or data that is obtained by further processing of the data generated by the device. Further processing of data generated by a device may include scaling the data, applying a function to the data, or determining a moving aggregate value based on a plurality of values generated by the device, for example, a moving average.

In an embodiment, the devices 130 are client devices used by users to interact with the knowledge based AI system 150. The users of the devices 130 include experts that configure the knowledge based AI system 150. In an embodiment, the device 130 executes an application 135 that allows users to interact with the knowledge based AI system 150. For example, the application 135 executing on the device 130 may be an internet browser that interacts with web servers executing on knowledge based AI system 150.

Systems and applications shown in FIG. 1 can be executed using computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, video game system, etc.

The interactions between the devices 130 and the knowledge based AI system 150 are typically performed via a network 110, for example, via the internet. In one embodiment, the network uses standard communications technologies and/or protocols. In another embodiment, the various entities interacting with each other, for example, the knowledge based AI system 150 and the devices 130 can use custom and/or dedicated data communications technologies instead of, or in addition to, the ones described above. Depending upon the embodiment, the network can also include links to other networks such as the Internet.

### System Architecture

FIG. 2 shows the system architecture of a knowledge first system, in accordance with an embodiment. The knowledge first system 120 comprises a knowledge model 210, a generalized model 220, an ensembled oracle 230, a data synthesizer 240, and a knowledge modeler 250. In other embodiments, the knowledge first system 120 may include more of fewer modules than those shown in FIG. 2. Furthermore, specific functionality may be implemented by modules other than those described herein. In some embodiments, various components illustrated in FIG. 2 may be executed by different computer systems. For example, the ensembled oracle 230 may be executed by one or more processors different from the processors that execute the knowledge model 210 and the generalized model 220. Furthermore, the various models of the knowledge first system 120 may be executed using a parallel or distributed architecture for faster execution.

The knowledge model 210 stores rules based on domain expertise. In an embodiment, the knowledge model 210 is a rule-based system. The rules may be provided by a domain expert. The rules may incorporate thresholds specified by experts that may be used to predict values or take actions. For example, if certain input is above a predetermined threshold value, certain action should be performed.

The generalized model 220 is a trained machine learning based model that makes predictions based on input data. The generalized model 220 may be incrementally trained as new training data is available. Accordingly, the generalized model 220 is evolving. For example, the generalized model 220 may be initialized using parameters that are obtained from a machine learning model trained using small training dataset. Periodically the generalized model 220 is trained using larger and better training dataset. Accordingly, the parameters of the generalized model 220 are updated using better trained models.

Each of the knowledge model 210 and the generalized model 220 makes a prediction and also outputs a measure of accuracy (or confidence score) associated with the predicted output. The measure of accuracy of each model is used to determine how the final output is determined based on the outputs of each of the models, i.e., the knowledge model 210 and the generalized model 220. The accuracy of the generalized model 220 may be determined during a model evaluation phase and provided with the model, for example, as a function (or set of instructions) that calculates the model accuracy. In an embodiment, the knowledge model 210 uses boolean rules, for example, rules specified as if-then-else statements that compare input data with thresholds to determine the result. In another embodiment, the knowledge model 210 uses fuzzy logic that has multi-valued variable (compared to boolean variables that can take only two values). For example, the knowledge model 210 may receive some data and determine statistics describing the data to generate fuzzy logic.

The ensembled oracle 230 determines whether to use the prediction of the generalized model 220 or to use the prediction based on knowledge model 210. Accordingly, if the ensembled oracle 230 determines that the prediction of the generalized model 220 is less accurate (having accuracy below a threshold value or having a confidence score below a threshold value), the ensembled oracle 230 uses the prediction of the knowledge model 210. If the ensembled oracle 230 determines that the prediction of the generalized model 220 is accurate (having accuracy above a threshold value or having a confidence score above a threshold value), the ensembled oracle 230 uses the prediction of the generalized model 220.

In an embodiment, the ensembled oracle 230 determines a result by combining the results of the generalized model 220 and the knowledge model 210. For example, if the output of each of the knowledge model 210 and the generalized model 220 is boolean, the ensembled oracle 230 performs an AND operation on the outputs of the knowledge model 210 and the generalized model 220 and returns the result of the AND operation as the overall prediction. In an embodiment, the ensembled oracle 230 determines the final result by taking a weighted aggregate of the outputs of the knowledge model 210 and the generalized model 220. The weights assigned to each output may be determined based on a measure of accuracy of the corresponding models executed for determining the output.

In an embodiment, the ensembled oracle 230 compares the accuracy of the knowledge model 210 and the generalized model 220 and selects the output of the model that has higher accuracy. In an embodiment, the ensembled oracle 230 itself is a machine learning based model.

The result of the ensembled oracle 230 is used by a production system for operation. The results are also stored (e.g., logged) and used later for evaluation of the models, for example, knowledge model 210 and generalized model 220. For example, the execution results may be provided by the system to an expert user. The expert user may revise the rules or threshold values used by rules for subsequent execution based on the past execution results. Accordingly, the system receives revised rules subsequent to presentation of the execution results.

The knowledge model 210 is also used for generating training data, for example, for labelling data used for training the generalized model 220. However, the knowledge model 210 is also used at execution time for making predictions when the results of the generalized model are determined to have low accuracy.

The data synthesizer 240 includes a model used for automatically generating data relevant for a system, for example, industrial system. The data synthesizer 240 may include a mathematical model that may be provided by experts. The data synthesizer 240 may include representations of noise that can be added to data generated using mathematical models to determine realistic data that may be used as initial training data set. The training data set generated by the data synthesizer 240 is used for training of the generalized model 220. The model used by the data synthesizer 240 for generating may be domain specific. However, the data synthesizer 240 may use generic techniques such as Monte Carlo techniques to generate data.

In an embodiment, each of the knowledge model 210 and the generalized model 220 can be configured to perform preprocessing of the input data. In an embodiment, the outputs of each of the knowledge model 210 and the generalized model 220 are in the same format, structure, and type so that the ensembled oracle 230 can combine the two outputs to generate the final output. The same raw data is provided as input to both the knowledge model 210 and the generalized model 220, however, the preprocessing of the two models may be different.

The knowledge modeler 250 allows an expert to configure the knowledge model 210. In an embodiment, the knowledge modeler 250 configures a user interface and send it for presentation to an expert user. The expert user can use the user interface to perform operations such as setting thresholds, creating polygons and shapes to create boundaries to mark subsets of data that are associated with specific semantics or for labelling the data, and so on.

### Overall Process

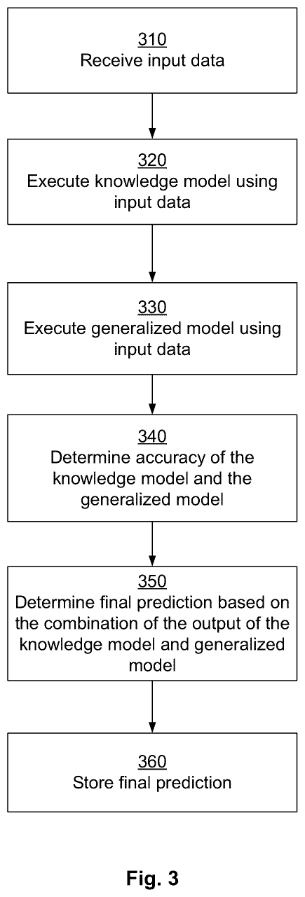

FIG. 3 illustrates the overall process for making predictions, according to an embodiment of the invention. The steps illustrated in the process may be performed in an order different from that indicated in FIG. 3. Furthermore, the steps are indicated as being performed by a system, for example, the knowledge based AI system 150 and may be performed by the appropriate module as shown in FIG. 2 and described in connection with description of FIG. 2.

The system receives 310 input data that needs to be processed for making certain prediction. The input data may be sensor data, event data generated by a system, user data, or any other type of data that may be provided as input to a model for making predictions. The system executes 320 the knowledge model 210 using the input data to generate an output, for example, O₁. The system executes 330 the generalized model 220 using the input data to generate another output, for example, O₂. The system determines 340 the accuracy of each of the knowledge model 210 and the generalized model 220. The system determines 350 a final prediction, for example, O₃ based on the combination of the output O₂ of the knowledge model 210 and the output O₂ of the generalized model 220. The system stores the final prediction O₃ and also uses it for taking further downstream actions. The generalized model 220 may also be referred to herein as a machine learning based model.

### Artificial Intelligence Based Systems

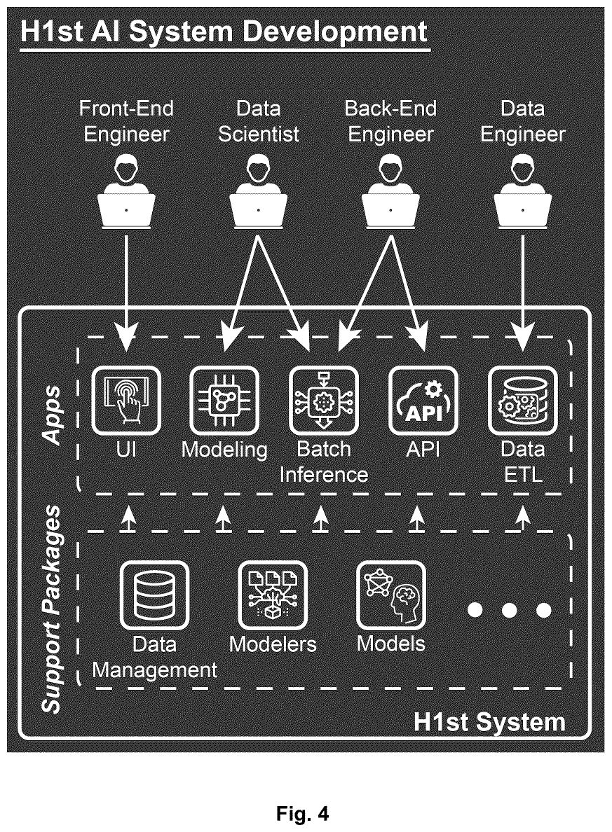

FIG. 4 shows a development system for use for building AI systems according to an embodiment. The development system is based on a particular structure for comprehensive AI systems, i.e. systems that go all the way from development to operation, made up of multiple microservices (apps) working together to meet system demands. Notebooks are sufficient for one model, not the whole system. The development system provides the tools needed to utilize individual streams of development. For example, back-end engineers can work on creating the batch inference app even before models are created since certain functionality is guaranteed in all models, ML or otherwise. The development system allows multiple people to progress separate development streams simultaneously while maintaining system integrity.

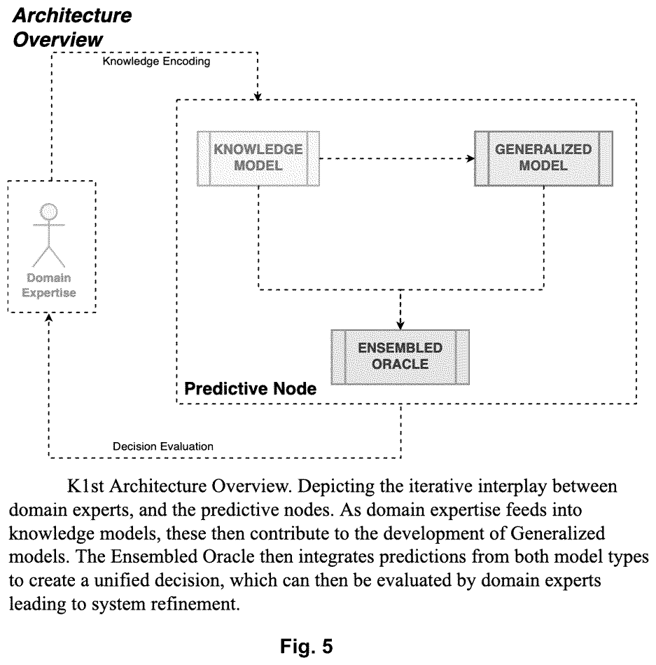

FIG. 5 illustrates the overall architecture of the knowledge based AI system according to an embodiment. The diagram illustrates the interactions between the domain experts and the various components of the knowledge based AI system 150 for making predictions.

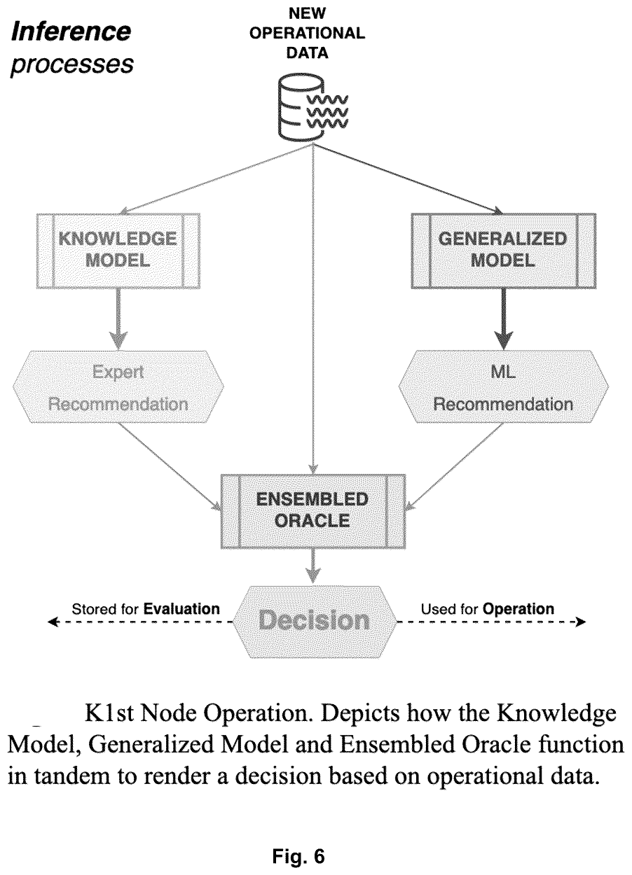

FIG. 6 illustrates the overall process of making predictions using the knowledge based AI system according to an embodiment. FIG. 6 illustrates the flow of information through the various components of the knowledge based AI system 150.

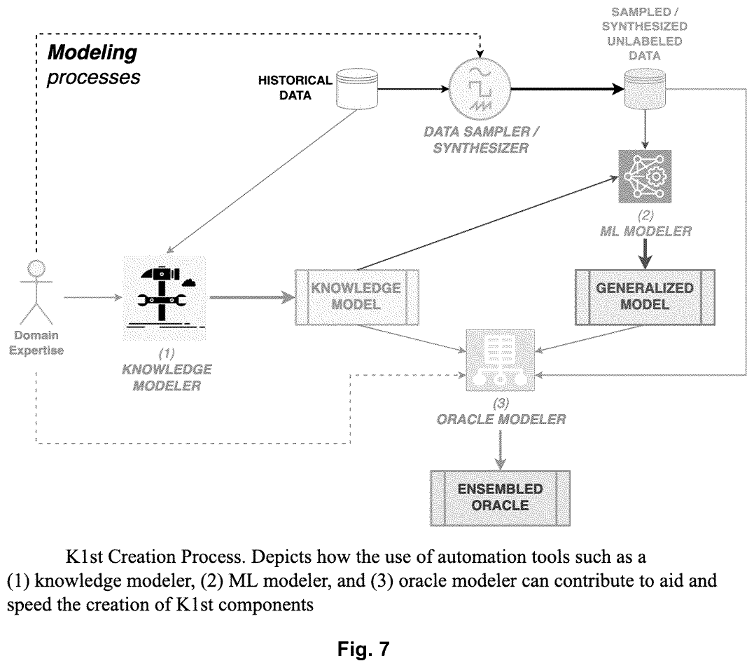

FIG. 7 illustrates the use of various tools for use with knowledge based AI system 150 according to an embodiment. For example, tools such as knowledge modeler and machine learning modeler may be used.

The knowledge first system 120 can be used for various applications, for example, applications in industrial systems. An example of an application where the knowledge first system 120 can be used is predictive maintenance and fault prediction of equipment.

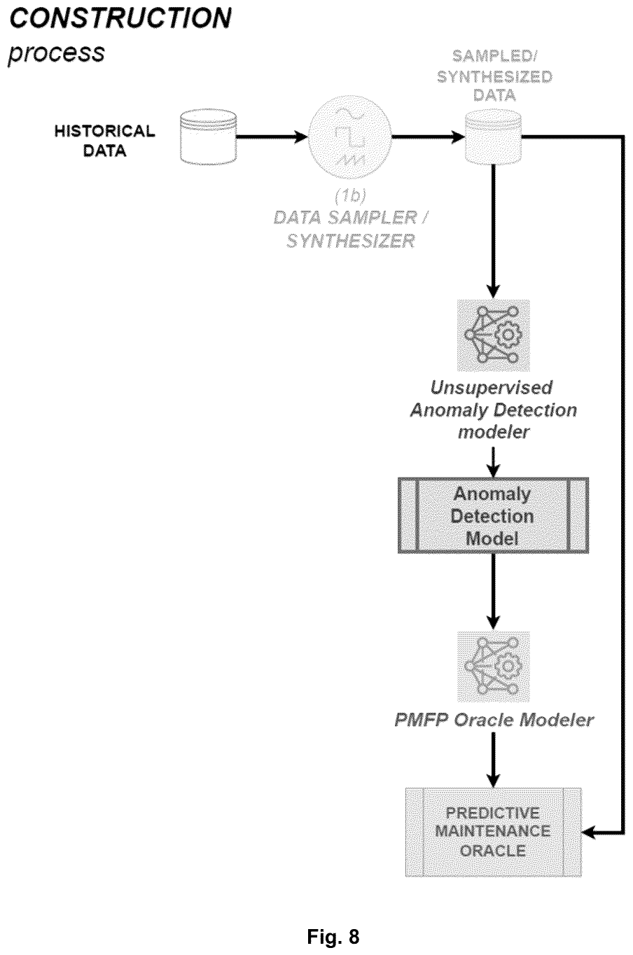

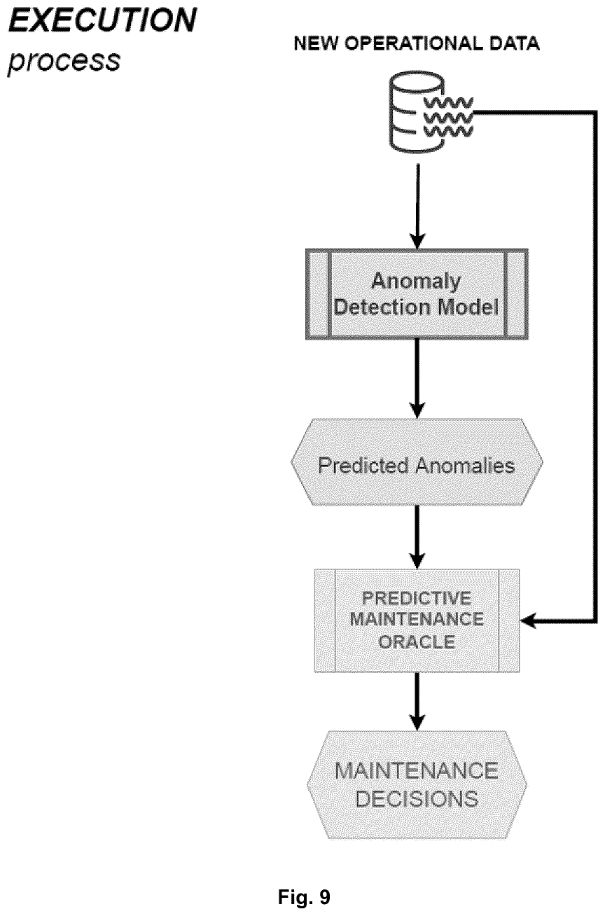

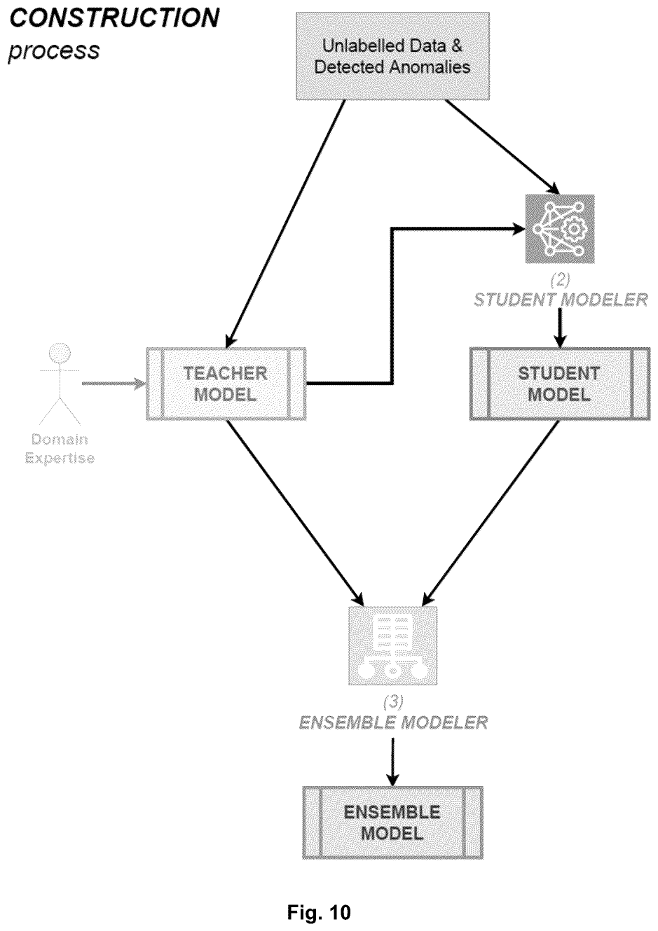

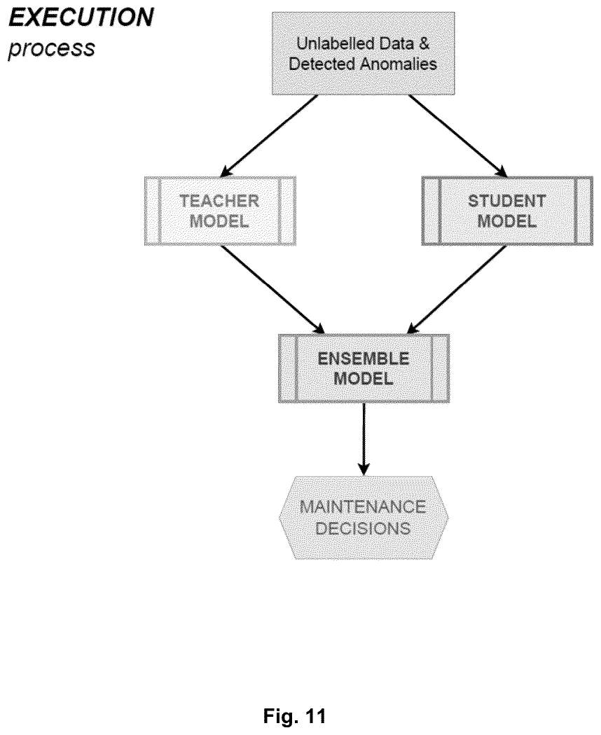

FIGS. 8-11 illustrate the use of the knowledge based AI system for applications according to various embodiments.

This diagram is an application of the K1st Oracle architecture. This is a generalized application for predictive maintenance where first data passes through an unsupervised anomaly detection process and then through the k-Oracle. The Oracle is a a node where a user would provide the knowledge model (Teacher) and then the system creates the Generalized ML model (student) and default Ensembler (though this can be customized as well). The Teacher is essentially a collection of rules laid out by a domain expert dictating what type of faults are associated with certain patterns in the data. For example, an expert could say ‘If the Outlet temperature is higher than the inlet temperature by 40 deg C. then you “re experiencing a coolant leak’, the Teacher model would have a rule ‘If anomaly & data [“outlet_temp”]-data [“inlet_temp”]>40: return “coolant_leak”‘. During the training process all of the data goes through the teacher model to create the labels used to train the Student model (in this particular case the student model used a Naive Bayes classifier at its base, however other implementations use deep neural network models). The advantage of this is that ML models are more flexible and perform better on edge cases where the hardline Teacher model might become inaccurate. Finally, the outputs of both models are passed to the Ensemble models which decides how to preference both predictions. At the simplest implementation the Ensemble can simply combine the 2 inputs (for example if the Student and Teacher output boolean classification then an AND or OR gate might suffice), but the Ensemble could also receive evaluation metrics from the 2 models and decide who's output to trust based on that, or if the outputs are numeric it could use the accuracy to weight and average the outputs. All of these choices are use case specific. At the highest level, if there is sufficient labelled training data, the ensemble can be implemented as an ML model and learn on its own how to best leverage both model predictions to generate a decision. While most companies with small data will start out with a logical ensemble, over time system usage will label their data for them and occasional expert evaluation/feedback will be used to edit and modify that dataset, which will eventually become large enough to support training of an ML ensemble. The key for this architecture is the k-Oracle and it varied possible implementations/uses. It is s an expandable architecture that can be slotted into many use cases and serves as a simple method of integrating domain expertise into AI and leveraging it to overcome the hurdle of having little to no training data or labels. Notably, this system can also train and run without any data at all. In that situation the ML model would effectively give a random output and the ensemble would only use the Teacher output, until sufficient data is available to train the student model.

### Collaborative Augmented Language Models for Developing AI Solutions

Often the domain specific knowledge that needs to be incorporated into a model is not available with a specific individual but distributed across multiple users. Furthermore, these users also may not have the full knowledge upfront. The system builds a library or libraries that store knowledge obtained from various users. When a user builds a model, the knowledge is extracted from the library.

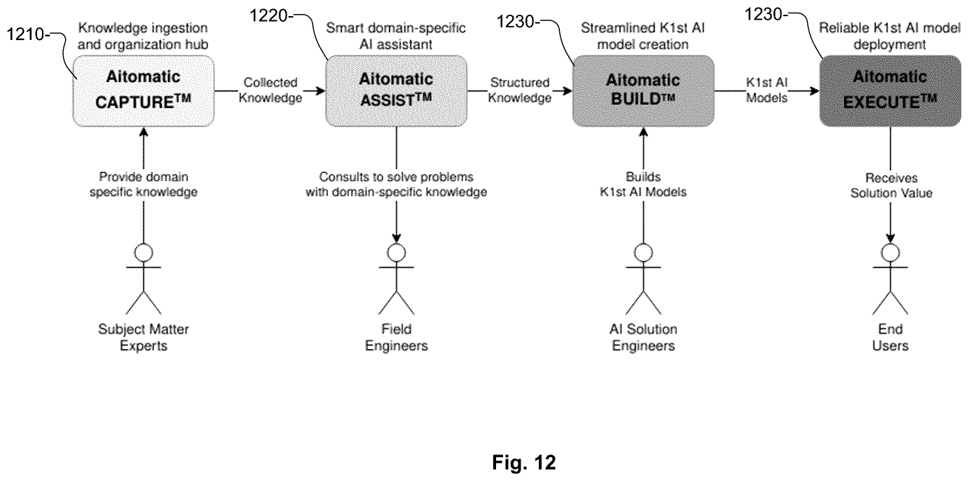

FIG. 12 shows the architecture of the system for developing AI solutions according to an embodiment. The system comprises a knowledge capture module 1210, a knowledge management module 1220, a digital subject matter expert (dSME) module 1230, and a knowledge translation (K-translator) module 1240. Other embodiments may have more or fewer modules than indicated in FIG. 12.

The knowledge capture module 1210 module is responsible for extracting expert knowledge (or domain knowledge) from subject matter experts in a conversational format. The module may use natural language processing (NLP) techniques to understand the knowledge being provided by the subject matter experts and work with them to arrive at a complete and accurate form of their knowledge. Users may upload documents storing domain specific knowledge to the libraries, for example, PDF documents, text files, doc files, and so on. This module, having access to existing knowledge within the catalog, would be enabled to understand the domain of the expert and actively seek to (A) extract further, more complete, information, and (B) actively collaborate with the expert to make the knowledge complete and/or correct. According to an embodiment, the knowledge capture module 1210 is a chatbot trained to perform conversations with domain experts and ask questions for extracting information from the domain experts. According to an embodiment, the knowledge extracted is stored in a vector database, for example, GPT Index, or Langchain™. The vector database allows relevant portions of the knowledge stored to be extracted for answering domain specific questions based on the domain knowledge extracted. According to an embodiment, the knowledge capture module 1210 performs conversations with a user and builds a summary of the conversation, for example, by providing the conversation to a large language model in one or more prompts and requesting the large language model (LLM) to summarize the conversation with the domain expert and using the response of the LLM as the summary of the conversation. Accordingly, the knowledge capture module 1210 allows the system to use LLMs to convert natural language based domain specific knowledge obtained from one or more users and convert the knowledge into structure data that is stored in library, for example, a vector database. The system builds domain specific models (e.g., domain specific LLMS) using the knowledge stored in the library.

A large language model may also be referred to herein as a machine learning based language model. In one embodiment, the large language models (LLMs) are trained on a large corpus of training data to process natural language requests. An LLM may be trained on large amounts of text data, often involving billions of words or text units. An LLM may be trained on a large amount of data from various data sources. For example, the data sources include websites, articles, posts on the web, and the like. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

In one instance, the LLM may be trained and deployed or hosted on a cloud infrastructure service. In one embodiment, the LLM has a generative pre-training (GPT) architecture including a set of decoders that each perform one or more operations to input data to the respective decoder. In another embodiment, the LLM has a transformer architecture that includes a set of encoders coupled to a set of decoders. While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

The knowledge management module 1220 is responsible for cataloging and summarizing the extracted knowledge. The module may use NLP techniques to summarize the knowledge and store it in a knowledge library. The knowledge library is searchable and accessible by users and is capable of ingesting conversations with the knowledge capture module 1210 as well as other forms of knowledge such as word documents and pdfs to act as a complete knowledge repository for users or organizations.

The digital subject matter expert module 1230 is responsible for ingesting the cataloged knowledge and using it to guide data scientists in building AI models. The digital subject matter expert module 1230 may use the knowledge library to provide answers to questions asked by data scientists and suggest relevant knowledge that may be helpful in building the AI model. This module (or modules, may use separate knowledge libraries based on topic or some other criteria) acts as a singular touchpoint between the available knowledge catalog and data scientists who build models or other users who wish to know specific information from the catalog. A digital subject matter expert module 1230 may also be referred to herein as a domain specific model.

The knowledge translation module 1240 is responsible for translating the extracted knowledge into a structured form, or a domain specific language (DSL), that can be used for simplified editing of the knowledge and building AI models based on that knowledge (and optionally, a corresponding data set).

The system provides several advantages over existing systems and methods for AI development. The use of a conversational format for capturing expert knowledge allows for a more natural and user-friendly flow for capturing expert knowledge. The cataloging and summarization of the extracted knowledge allows for the knowledge to be easily managed and queried. The use of a dSME to guide data scientists in building AI models provides a more natural and user-friendly interface for acquiring the knowledge needed to build the models.

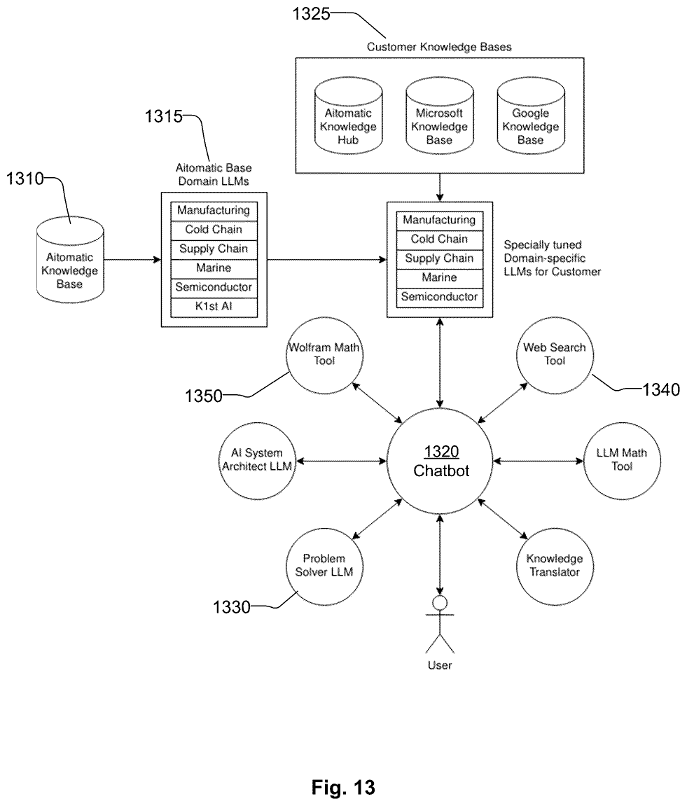

FIG. 13 illustrates the interactions between various components of the system according to an embodiment. The system stores domain specific LLMs 1315 in a knowledge base 1310. For example, a domain specific LLM 1315 may be trained using information about manufacturing, another domain specific LLM 1315 may be trained using information about cold chain, another domain specific LLM 1315 may be trained using information about supply chain, and so on. A knowledge base may be provided to tenants of the system and a tenant may provide its own tenant specific knowledge base 1325. Thus, the system may include tenant specific LLMs that has domain specific knowledge that is also tenant specific. Each domain specific LLM acts as a digital subject matter expert (dSME).

The user interacts with the assistant chatbot 1320 (referred to as assistant chatbot or an Altomatic assistant chatbot) which in turn interacts with various components. The user may ask a natural language question to the assistant chatbot 1320 providing information about a problem (e.g., with an equipment) requesting the assistant chatbot 1320 to diagnose the problem. The assistant chatbot 1320 answers the question if the assistant chatbot 1320 has the right information/knowledge or else the assistant chatbot 1320 determines which tool (or component) to interact with to get the answer. The assistant chatbot 1320 interacts with one or more tools to solve the user's problem. The assistant chatbot 1320 may split the request into multiple requests for different tools and interact with them to collect information and combines the information to solve the problem. According to an embodiment, the assistant chatbot 1320 interacts with a problem solver LLM 1330 to break down the user problem into smaller problems or steps.

According to an embodiment, the system receives sensor data. The system interacts with the domain specific LLMs to identify specific information needed to solve a particular problem. The system builds a model for solving that specific problem. The system subsequently uses that model for solving the problem for new data received. If the system encounters a problem that cannot be solved by the system, it sends a message to an expert for help.

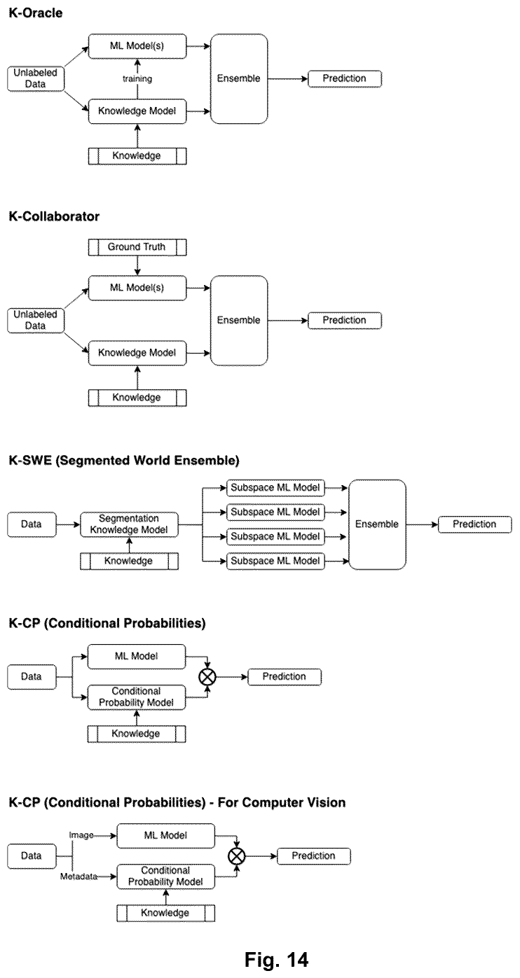

FIG. 14 illustrates four Knowledge-First (K1st) Architectures. Each solves a different type of data or prediction problem.

The K-Oracle & K-Collaborator are similar except for the fact that K-Oracle is used when there are no data labels (or no good data labels), and it instead uses the Knowledge Model as a teacher for the ML “Student” Models. K-Collaborator, on the other hand, is used when there are ground truth labels for the data, but the benefit of knowledge is still required.

Both of these architectures are used in small data scenarios when the system lacks sufficient data or sufficient examples of the key prediction events, and human knowledge is leveraged to help capture events that data-only ML would normally miss or fail to learn. These 2 architectures can take advantage of rules type knowledge (e.g. If X then Y) to accomplish classification tasks or rules (e.g. if X then Y changes by Z) and equation (e.g. Y=ax+b) type knowledge to accomplish regression or forecasting tasks.

Additionally, while the K-Oracle is made up of a single knowledge “Teacher” model and one or many ML “Student” models, the K-Collaborator can include an arbitrary number of Knowledge and ML models. In both cases the ensemble can be any algorithm (knowledge-based or ML) that decides on how to best combine, compare or choose from among the upstream model outputs.

The K-SWE architecture is best suited when there is a middling or large amount of data but large variance in the output variable (e.g., when forecasting number of customers and total sales for a convenient store, there is large variance in the number of customers and total sales across stores & time). This architecture takes advantage of the fact that Machine Learning strives to learn the inherent trends & relationships of the data space but may fail when there is (A) insufficient data to fully learn all of the required relationships, (B) trends are not well represented in the data set or (C) the best features to understand the trend mathematically are not in the data set. However, experts already understand many of the major trends that separate out the data space; so utilizing their trend type knowledge (e.g. A and B are more similar than A and C, or Y is more stable for each group within feature X), we can segment the data into discrete subspaces removing major trends in the data and allowing ML to better learn the remaining trends using less data. For example, assume I'm making a model to predict the number of people visiting a park, as an expert I know that the seasons each mark distinct differences in park goer activity as well as the weather. So instead of fitting one model across all months and cities to predict the number of people in the park, I can fit one model to predict the number of park goers in summer, another for winter, one for rainy days, one for sunny days and one for sunny summer days. On inference only the relevant models would run, so on a sunny summer day 3 models would run: summer model, sunny model and sunny summer model, and all 3 outputs would be ensembled for a better prediction. Further this system inherently scales to predict for situations not in the original data set. Say the initial data set doesn't have any instances of sunny winter days, but during operation there is a sunny winter day. Then 2 models would still run: winter model and sunny model, and these 2 outputs would be ensembled.

Compounding this model with other K1st models is also possible, since the “Subspace ML Model” can actually be any type of predictive model. As such, you can have a K-SWE model where each Subspace Model is a K-Oracle, preventing the need for any data labels.

The K-CP (Conditional Probabilities) architecture connects ML and Knowledge but using knowledge to directly affect the probability space of ML models. ML models inherently compute the conditional probability of potential outputs as the probability of output Y given the data X. We can similarly use knowledge to create a conditional probability model that also computes the probability of output Y given the data X and combine this with the ML probabilities before the final steps of ML processing (thresholding, softmax, weighted averaging, etc). This architecture is especially useful when the knowledge is applied to information not seen by the ML model. A perfect example of this is in compute vision cases where the ML model is only looking at an image and making some prediction. While the ML model sees the image, it does not see (and thus does not act on) metadata associated with the image-such as the time, place, and external conditions under which the image was taken. In this case the ML model acts on the image to produce the probabilities of output Y given data X, and the knowledge model (conditional probability model) acts on the metadata to produce the probability of output Y given the metadata Z. Now both of these probabilities can be combined to give a more informed (and thus more accurate) result.

The method can also be used when both ML and Knowledge model are seeing the same data since humans can review model output and directly inject knowledge to correct for things that ML is explicitly failing to learn (usually because there is insufficient data for the ML to learn). Alternatively, this architecture can be used to intentionally bias AI systems using knowledge to prevent adverse outcomes, such as intentionally reducing false negatives in mission critical systems in favor of false positives (since reacting to a failure that doesn't happen is safer than missing a failure that does happen).

### Applications of AI System

The system as disclosed (referred to herein as the CALM system) has been applied to or is designed to work with various applications as follows.

The system is applicable to predictive maintenance for industrial equipment. By integrating the CALM system with various sensors and data sources, it could be used to predict equipment failures before they happen, reducing downtime and maintenance costs for industrial equipment.

The system is applicable to autonomous vehicle control. The CALM system could be used to integrate multiple domain-specific models and human operators to enable autonomous control of vehicles. This could improve safety and efficiency in various settings, such as shipping ports or large-scale mining operations.

The system is applicable to energy optimization in smart buildings. By integrating the CALM system with smart building technologies and data sources, the system is used to optimize energy usage and reduce waste in buildings. This could lead to significant cost savings and environmental benefits.

The system is applicable to medical diagnosis and treatment. The CALM system could be used to integrate multiple domain-specific models and human operators to aid in medical diagnosis and treatment planning. For example, the system could be used to combine data from medical imaging scans, laboratory tests, and patient histories to provide more accurate diagnoses and treatment recommendations.

The system is applicable to environmental monitoring and control. The CALM system could be used to integrate data from various environmental sensors and models to enable more effective monitoring and control of natural resources, such as water and air quality. This could have significant benefits for public health and environmental conservation efforts.

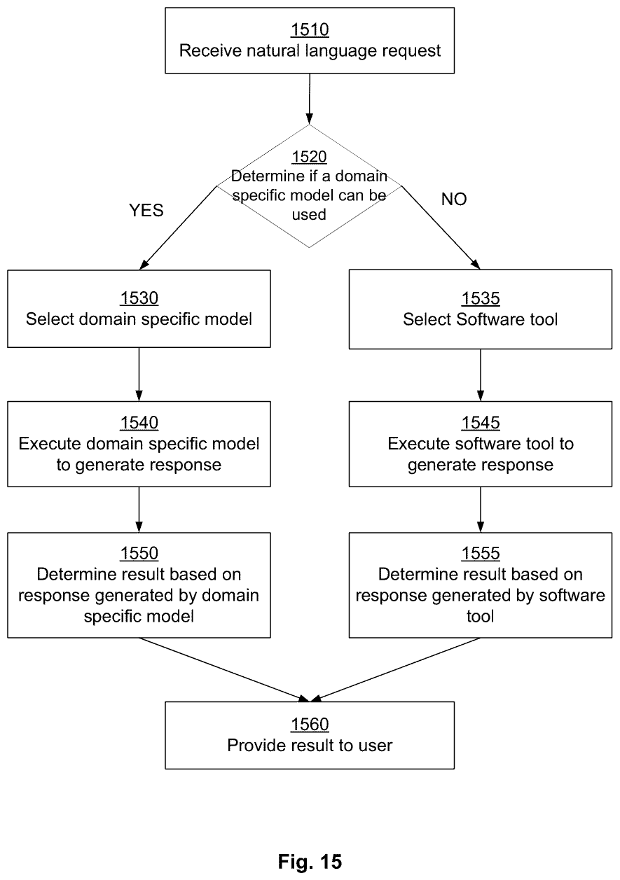

FIG. 15 shows a flowchart illustrating the process of answering domain specific natural language requests, according to an embodiment. The steps may be performed by modules of a system, for example, the knowledge based AI system 150. The steps may be performed in an order different from that indicated herein.

The system receives 1510 a natural language request. The natural language request represents a domain specific problem that a user is interested in solving. The request may be received by the chatbot 1320 configured to receive and process natural language requests, perform a processing based on the natural language request and generate a response based on the natural language request. For example, the natural language request may be specific to an industry and requesting a solution to a problem that occurred in an equipment used in that industry. The natural language request may specify details of the equipment and the symptoms of the problem, for example, the equipment may be refrigeration equipment of a particular type (specified using the vendor name and model number), and the problem may be that the refrigeration equipment is not cooling below certain point. The natural language request may further specify details of the system environment of the equipment, for example, the type of facility where the refrigeration equipment is installed, the temperature of the surroundings, the size of the area that is being cooled by the refrigeration equipment, and so on.

The system determines 1520 if a domain specific model (also referred to as dSME) accessible to the system is able to solve the domain specific problem specified by the natural language request. For example, the system determines whether a particular domain specific knowledge is based on the knowledge required for solving the domain specific problem specified by the natural language request. If there is a domain specific model that is based on knowledge of the domain of the domain specific problem, the system selects 1530 the domain specific model from the plurality of domain specific models accessible to the system. The system executes 1540 the domain specific model to generate a response. For example, an LLM may return a response in a format requested in a prompt such as a JSON (JavaScript Object Notation) object. The system determines 1550 the result based on the response, for example, by extracting an attribute of a JSON object representing the result. The system provides 1560 the result to the user, for example, by sending it to a client device of the user.

If the system determines 1520 that none of the available domain specific models accessible to the system are able to solve the domain specific problem specified by the natural language request, for example, if none of the available domain specific models store or are trained using data of that particular domain, the system uses a software tool for solving the problem. Accordingly, the system selects 1535 a software tool from a plurality of software tools accessible to the system, for example, a search engine. The system may select a software tool by using an LLM, for example, by providing a prompt to the LLM describing the available software tools and the natural language request and requesting the LLM to identify the best software tool for solving the domain specific problem.

The system executes 1545 the selected software tool to generate a response. For example, the system may extract one or more search keywords from the natural language request and generate a search request for the search engine comprising the search keywords. The search engine may return a set of search results matching the search request. The system determines 1555 the result based on the response, for example, by extracting a search result from the set of search results. The system provides 1560 the result to the user, for example, by sending it to a client device of the user.

According to an embodiment, the system uses an LLM to determine which search result from the set of search result is the best search result matching the search request. The system generates a prompt comprising one or more search results and the natural language request and a request to determine whether the search result comprises information for answering the domain specific problem specified by the natural language request. The system provides the prompt as input to an LLM. The system receives a response obtained by executing the LLM. The system selects a result from the set of search results based on a response obtained by executing the large language model.

According to an embodiment, the system may have access to a plurality of domain specific models, each configured to solve problems for a domain. The system may store description of the domain specific models and compare the natural language request with the domain specific model. According to an embodiment, the system stores the descriptions of the domain specific models in a vector database. For example, the system may generate a vector representation of each description of domain specific model and stores the vector representations in a vector database. A vector representation of a natural language text may be generated by providing the natural language text as input to a neural network, for example, a multilayered perceptron trained to encode and decode an input natural language text. The vector representation may be the output of a hidden layer of the neural network processing the natural language text.

The system further generates a vector representation of the natural language request and compares the vector representation of the natural language request with the vector representations of the descriptions of domain specific models to determine which domain specific model is closest to the natural language request. The comparison may be based on a vector distance metric, for example, a cosine similarity measure. If the distances of all the vector representations of descriptions of domain specific models from the vector representation of the natural language request exceed a predetermined threshold value, the system may determine 1520 that there is no domain specific model that is capable of solving the problem described in the natural language request.

According to another embodiment, the system determines 1520 the appropriate domain specific model using a large language model. The system generates a prompt comprising a description of each of the plurality of domain specific models, the natural language request, and a request to determine whether any of the plurality of domain specific models is capable of solving the domain specific problem specified in the natural language request. The system provides the prompt to an LLM for execution. The LLM may be executed by an external system, for example, a web service or may be stored and executed locally. If the LLM is executed by an external system, the system executes the LLM by sending a request over the network, for example, a request to execute an API (application programming interface) of the external system. If the LLM is executed locally within the system, the system may simply invoke a function to execute the LLM. The system receives a response obtained by execution of the large language model. The system extract from the response, an indication of whether any of the plurality of domain specific models is capable of solving the domain specific problem specified in the natural language request.

According to an embodiment, the system may indicate in the prompt that the LLM should select a domain specific model for solving the domain specific problem specified by the natural language request if any of the plurality of domain specific models is capable of solving the domain specific problem. Accordingly, the LLM selects one of the domain specific model if the domain specific model has the knowledge required to solve the domain specific problem specified by the natural language request. The system extracts from the response, information identifying a domain specific model that is capable of solving the domain specific problem specified in the natural language request.

According to an embodiment, a domain specific model comprises (1) a machine learning based model trained to make a prediction based on a particular input data, (2) a knowledge model wherein the knowledge model is a rule-based model, wherein each rule makes a prediction based on one or more characteristics of input data, and (3) an ensemble model configured to combine results of the knowledge model and the machine learning based model. The ensemble model combines results of the knowledge model and the machine learning based model.

The knowledge model may store rules based on domain expertise. In an embodiment, the knowledge model is a rule-based system. The rules may be provided by a domain expert. The rules may incorporate thresholds specified by experts that may be used to predict values or take actions. For example, if certain input is above a predetermined threshold value, certain action should be performed.

The machine learning based model of the domain specific model is a trained machine learning based model that makes predictions based on input data. The machine learning based model may be incrementally trained as new training data is available. Accordingly, the machine learning based model is evolving. For example, the machine learning based model may be initialized using parameters that are obtained from a machine learning model trained using small training dataset. Periodically the machine learning based model is trained using larger and better training dataset. Accordingly, the parameters of the machine learning based model are updated using better trained models. The knowledge model is also used for generating training data, for example, for labelling data used for training the machine learning based model.

According to an embodiment, the ensemble model combines results of the knowledge model and the machine learning based model based on a measure of accuracy of the knowledge model and a measure or accuracy of the machine learning based model. The measure of accuracy of each model may be one of the outputs predicted by the model. For example, a machine learning based model may be trained to predict a measure of accuracy along with the result. Similarly, a rule based system may include rules for predicting accuracy of a result.

According to an embodiment, if the ensemble model determines that the prediction of the machine learning based model of the domain specific model is less accurate (having accuracy below a threshold value or having a confidence score below a threshold value), the ensemble model uses the prediction of the knowledge model. If the ensemble model determines that the prediction of the machine learning based model of the domain specific model is accurate (having accuracy above a threshold value or having a confidence score above a threshold value), the ensemble model uses the prediction of the machine learning based model.

According to an embodiment, a knowledge model uses boolean rules, for example, rules specified as if-then-else statements that compare input data with thresholds to determine the result. In another embodiment, the knowledge model uses fuzzy logic that has multi-valued variable (compared to boolean variables that can take only two values). For example, the knowledge model may receive some data and determine statistics describing the data to generate fuzzy logic.

According to an embodiment, the ensemble model is configured to select an output of the machine learning based model as a final output if the measure of accuracy of the machine learning based model is higher than the measure of accuracy of the knowledge model and select the output of the knowledge model as the final output if the measure of accuracy of the knowledge model is higher than the measure of accuracy of machine learning based model. According to an embodiment, the ensemble model generates a final output that is a weighted aggregate of an output of the machine learning based model and an output of the knowledge model, wherein a weight of each output is determined based on a measure of accuracy of a corresponding model.

### Computer Architecture

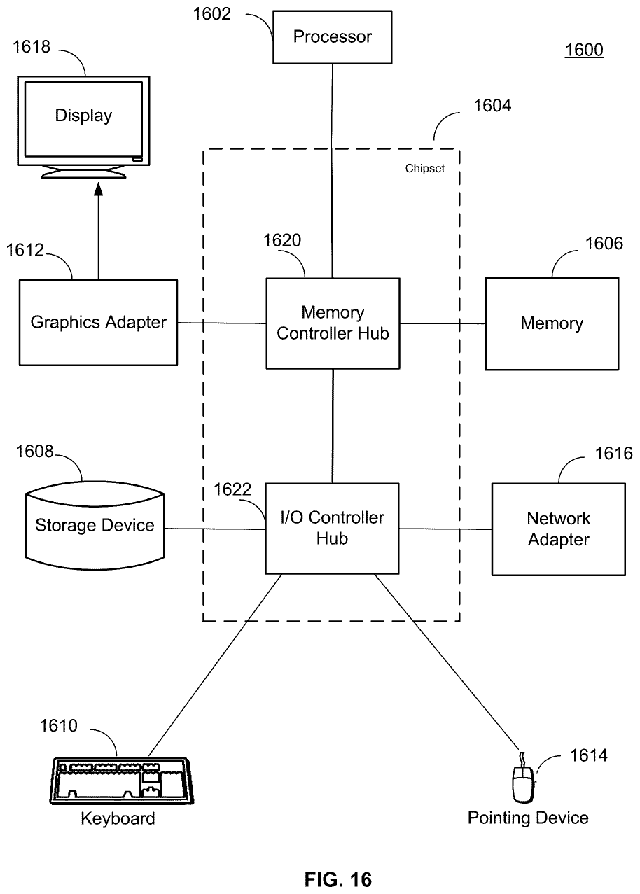

FIG. 16 is a high-level block diagram illustrating an example system, in accordance with an embodiment. The computer 1600 includes at least one processor 1602 coupled to a chipset 1604. The chipset 1604 includes a memory controller hub 1620 and an input/output (I/O) controller hub 1622. A memory 1606 and a graphics adapter 1612 are coupled to the memory controller hub 1620, and a display 1618 is coupled to the graphics adapter 1612. A storage device 1608, keyboard 1610, pointing device 1614, and network adapter 1616 are coupled to the I/O controller hub 1622. Other embodiments of the computer 1600 have different architectures.

The storage device 1608 is a non-transitory computer-readable storage medium such as a hard drive, compact disk read-only memory (CD-ROM), DVD, or a solid-state memory device. The memory 1606 holds instructions and data used by the processor 1602. The pointing device 1614 is a mouse, track ball, or other type of pointing device, and is used in combination with the keyboard 1610 to input data into the computer system 1600. The graphics adapter 1612 displays images and other information on the display 1618. The network adapter 1616 couples the computer system 1600 to one or more computer networks.

The computer 1600 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 1608, loaded into the memory 1606, and executed by the processor 1602. The types of computers 1600 used can vary depending upon the embodiment and requirements. For example, a computer may lack displays, keyboards, and/or other devices shown in FIG. 16.

### Additional Considerations

It is to be understood that the Figures and descriptions of the present invention have been simplified to illustrate elements that are relevant for a clear understanding of the present invention, while eliminating, for the purpose of clarity, many other elements found in a typical distributed system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-readable non-transitory memory storing instructions that when executed by one or more computer processors cause the one or more computer processors to perform steps of a method for solving domain specific problems specified using natural language requests, the steps comprising:
receiving, by a chatbot, a natural language request for answering a question from one of a plurality of domains, the natural language request comprising a domain specific problem;
determining whether any of a plurality of domain specific models are configured to answer the domain specific problem, each of the plurality of domain specific models storing a knowledge base specific to a domain;
responsive to determining that at least one of the plurality of domain specific models is configured to answer the domain specific problem specified in the natural language request, selecting a domain specific model from a plurality of domain specific models for answering the domain specific problem;
executing the domain specific model to answer the domain specific problem;
responsive to determining that none of the plurality of domain specific models can answer the domain specific problem, selecting a software tool from a plurality of software tools for answering the domain specific problem;
sending a request to the software tool for answering the domain specific problem; and
sending a result of execution of the software tool to a client device.

2. The computer-readable non-transitory memory of claim 1, wherein the instructions further cause the one or more computer processors to perform steps comprising:
for each of the plurality of domain specific models, storing vector representation of description of the domain specific model in a vector database;
determining a vector representation of the natural language request; and
for each of the plurality of domain specific models, determining a vector distance between the vector representation the natural language request and the vector representation the description of the domain specific model.

3. The computer-readable non-transitory memory of claim 2, wherein the instructions for determining whether any of a plurality of domain specific models are configured to answer the natural language request further cause the one or more computer processors to perform steps comprising:
responsive to, for each of the plurality of domain specific models, determining that the vector distance between the vector representation the natural language request and the vector representation the description of the domain specific model exceeds a threshold value, determining that none of the domain specific model is capable of solving the domain specific problem specified in the natural language request.

4. The computer-readable non-transitory memory of claim 1, wherein the instructions further cause the one or more computer processors to perform steps comprising:
generating a prompt comprising:
a description of each of the plurality of domain specific models,
the natural language request, and
a request to determine whether any of the plurality of domain specific models is capable of solving the domain specific problem specified in the natural language request;
sending the prompt to a large language model for execution;
receiving a response obtained by execution of the large language model; and
extracting from the response, an indication of whether any of the plurality of domain specific models is capable of solving the domain specific problem specified in the natural language request.

5. The computer-readable non-transitory memory of claim 4, wherein the prompt further requests the large language model to select a domain specific model for solving the domain specific problem if any of the plurality of domain specific models is capable of solving the domain specific problem, wherein the instructions further cause the one or more computer processors to perform steps comprising:
extracting from the response, a domain specific model configured to solve the domain specific problem specified in the natural language request.

6. The computer-readable non-transitory memory of claim 1, wherein at least a domain specific model comprises:
a machine learning based model trained to make a prediction based on a particular input data,
a knowledge model wherein the knowledge model is a rule-based model, wherein each rule makes a prediction based on one or more characteristics of input data, and
an ensemble model configured to combine results of the knowledge model and the machine learning based model.

7. The computer-readable non-transitory memory of claim 6, wherein the ensemble model combines results of the knowledge model and the machine learning based model based on a measure of accuracy of the knowledge model and a measure or accuracy of the machine learning based model.

8. The computer-readable non-transitory memory of claim 7, wherein the ensemble model is configured to select an output of the machine learning based model as a final output if the measure of accuracy of the machine learning based model is higher than the measure of accuracy of the knowledge model and select the output of the knowledge model as the final output if the measure of accuracy of the knowledge model is higher than the measure of accuracy of machine learning based model.

9. The computer-readable non-transitory memory of claim 6, wherein the ensemble model generates a final output that is a weighted aggregate of an output of the machine learning based model and an output of the knowledge model, wherein a weight of each output is determined based on a measure of accuracy of a corresponding model.

10. The computer-readable non-transitory memory of claim 1, wherein at least a software tool is a search engine, wherein the instructions cause the one or more computer processors to perform steps comprising:
extracting one or more search keywords from the natural language request;
providing the one or more search keywords to the search engine;
receiving a set of search results matching the one or more search keywords from the search engine; and
extracting a response to the natural language request form a search result selected from the set of search results.

11. The computer-readable non-transitory memory of claim 10, wherein the instructions for extracting the response to the natural language request from the search result selected from the set of search results cause the one or more computer processors to perform steps comprising:
generating a prompt comprising one or more search results and the natural language request and a request to determine whether the search result comprises information for answering the domain specific problem specified by the natural language request;
providing the prompt as input to a large language model; and
selecting a result from the set of search results based on a response obtained by executing the large language model.

12. A computer-implemented method for solving domain specific problems specified using natural language requests, the computer-implemented method comprising:
receiving, by a chatbot, a first natural language request for answering a question from one of a plurality of domains, the first natural language request comprising a first domain specific problem;
determining whether any of a plurality of domain specific models are configured to answer the first domain specific problem, each of the plurality of domain specific models storing a knowledge base specific to a domain;
responsive to determining that at least one of the plurality of domain specific models is configured to answer the domain specific problem specified in the natural language request, selecting a domain specific model from a plurality of domain specific models for answering the first domain specific problem;
executing the domain specific model to answer the first domain specific problem;
receiving, by the chatbot, a second natural language request for answering a question from one of a plurality of domains, the second natural language request comprising a second domain specific problem;
responsive to determining that none of the plurality of domain specific models can answer the second domain specific problem, selecting a software tool from a plurality of software tools for answering the second domain specific problem;
sending a request to the software tool for answering the second domain specific problem; and
sending a result of execution of the software tool to a client device.

13. The computer-implemented method of claim 12, further comprising:
for each of the plurality of domain specific models, storing vector representation of description of the domain specific model in a vector database;
determining a vector representation of the natural language request; and
for each of the plurality of domain specific models, determining a vector distance between the vector representation the natural language request and the vector representation the description of the domain specific model.

14. The computer-implemented method of claim 13, wherein determining whether any of a plurality of domain specific models are configured to answer the natural language request comprises:
responsive to, for each of the plurality of domain specific models, determining that the vector distance between the vector representation the natural language request and the vector representation the description of the domain specific model exceeds a threshold value, determining that none of the domain specific model is capable of solving the domain specific problem specified in the natural language request.

15. The computer-implemented method of claim 12, further comprising:
generating a prompt comprising:
a description of each of the plurality of domain specific models,
the natural language request, and
a request to determine whether any of the plurality of domain specific models is capable of solving the domain specific problem specified in the natural language request;
sending the prompt to a large language model for execution;
receiving a response obtained by execution of the large language model; and
extracting from the response, an indication of whether any of the plurality of domain specific models is capable of solving the domain specific problem specified in the natural language request.

16. The computer-implemented method of claim 12, wherein at least a domain specific model comprises:
a machine learning based model trained to make a prediction based on a particular input data,
a knowledge model wherein the knowledge model is a rule-based model, wherein each rule makes a prediction based on one or more characteristics of input data, and
an ensemble model configured to combine results of the knowledge model and the machine learning based model.

17. The computer-implemented method of claim 16, wherein the ensemble model is configured to select an output of the machine learning based model as a final output if a measure of accuracy of the machine learning based model is higher than a measure of accuracy of the knowledge model and select the output of the knowledge model as the final output if the measure of accuracy of the knowledge model is higher than the measure of accuracy of machine learning based model.

18. The computer-implemented method of claim 16, wherein the ensemble model generates a final output that is a weighted aggregate of an output of the machine learning based model and an output of the knowledge model, wherein a weight of each output is determined based on a measure of accuracy of a corresponding model.

19. The computer-implemented method of claim 12, wherein at least a software tool is a search engine, the computer-implemented method further comprising:
extracting one or more search keywords from the natural language request;
providing the one or more search keywords to the search engine;
receiving a set of search results matching the one or more search keywords from the search engine; and
extracting a response to the natural language request form a search result selected from the set of search results, comprising:
generating a prompt comprising one or more search results and the natural language request and a request to determine whether the search result comprises information for answering the domain specific problem specified by the natural language request,
providing the prompt as input to a large language model, and
selecting a result from the set of search results based on a response obtained by executing the large language model.

20. A computer system for solving domain specific problems specified using natural language requests, computer system the comprising:
one or more computer processors; and
a computer-readable non-transitory memory storing instructions that when executed by the one or more computer processors cause the one or more computer processors to perform steps comprising:
receiving, by a chatbot, a natural language request for answering a question from one of a plurality of domains, the natural language request comprising a domain specific problem;
determining whether any of a plurality of domain specific models are configured to answer the domain specific problem, each of the plurality of domain specific models storing a knowledge base specific to a domain;
responsive to determining that at least one of the plurality of domain specific models is configured to answer the domain specific problem specified in the natural language request, selecting a domain specific model from a plurality of domain specific models for answering the domain specific problem;
executing the domain specific model to answer the domain specific problem;
responsive to determining that none of the plurality of domain specific models can answer the domain specific problem, selecting a software tool from a plurality of software tools for answering the domain specific problem;
sending a request to the software tool for answering the domain specific problem; and
sending a result of execution of the software tool to a client device.
